(19) United States
(12) Patent Application Publication
(10) Pub. No.: US 2005/0203923 A1
(43) Pub. Date: Sep. 15, 2005

(54) Method and system of a network link adapter

(76) Inventor: Mark Alexander Shand, Damplerre-en-Yvelines (FR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/798,624

(22) Filed: Mar. 11, 2004

(51) Int. Cl. G06F 17/00

(52) U.S. Cl. 707/100

(57) ABSTRACT

In at least some embodiments, a system may comprise a network link adapter, wherein the network link adapter is configurable to detect when a first device transmits data targeting a second device and write the data targeting the second device to an address of a memory. The system further comprises a monitoring unit coupled to the network link adapter, the monitoring unit detects when the data is written to the address of the memory and forwards the data to the second device.

### BACKGROUND

When a network adapter interfaces different network links, the speed of communication on the network may be undesirably limited by the slowest link. Therefore, methods and systems that increase the speed of communication between different network links are desirable.

### SUMMARY

In at least some embodiments, a system may comprise a network link adapter, wherein the network link adapter is configurable to detect when a first device transmits data targeting a second device and write the data targeting the second device to an address of a memory. The system further comprises a monitoring unit coupled to the network link adapter, the monitoring unit detects when the data is written to the address of the memory and forwards the data to the second device.

### BRIEF DESCRIPTION OF THE DRAWINGS

For a detailed description of exemplary embodiments of the invention, reference will now be made to the accompanying drawings in which:

FIG. 1 illustrates a block diagram of a system in accordance with embodiments of the invention;

FIG. 2 illustrates a flow of data in the system of FIG. 1 in accordance with embodiments of the invention; and

FIG. 3 illustrates a method in accordance with embodiments of the invention.

### Notation and Nomenclature

Certain terms are used throughout the following description and claims to refer to particular system components. As one skilled in the art will appreciate, computer companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure. In addition, one skilled in the art will understand that the following description has broad application, and the discussion of any embodiment is meant only to be exemplary of that embodiment, and not intended to intimate that the scope of the disclosure is limited to that embodiment.

As will be disclosed below, various embodiments of the invention improve the speed of communication in a multi-link network. In at least some embodiments, the speed of network communication may be improved by detecting when a first device transmits data targeted for a second device and providing an alternate route (separate from a network link that couples the first and second devices) for the targeted data to be received by the second device. The second device may thereby simultaneously receive data from the first device via the alternate route and output data to the first device via the network link.

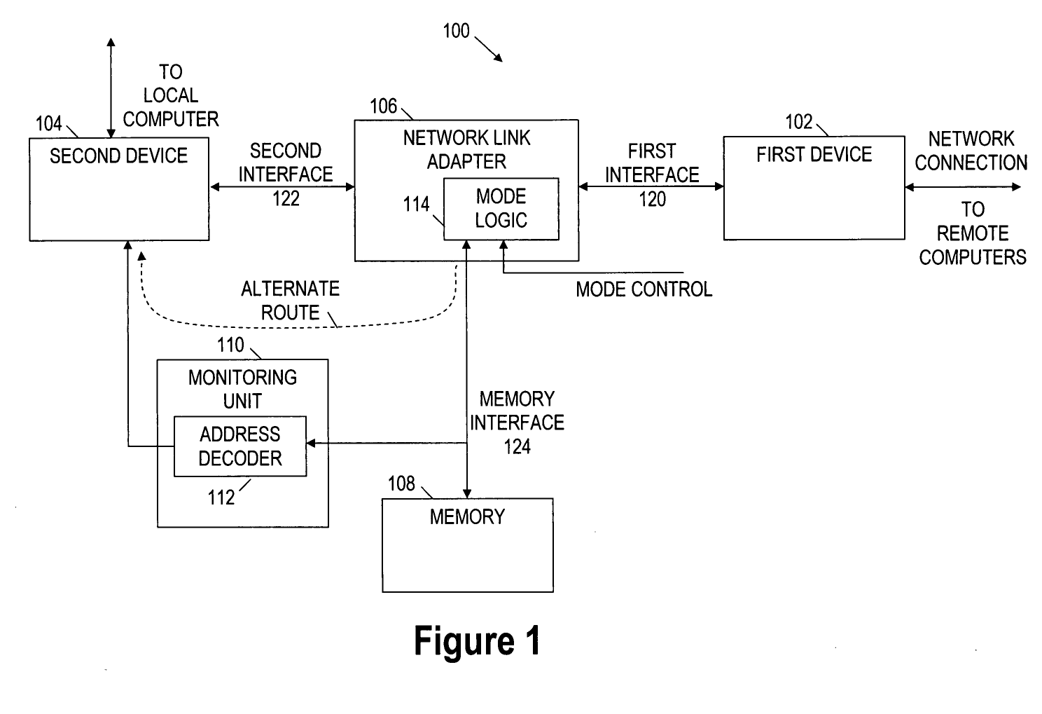

FIG. 1 illustrates a system 100 in accordance with embodiments of the invention. As shown in FIG. 1, the system 100 may comprise a first device 102 and a second device 104 coupled to a network link adapter 106 via a first interface 120 and a second interface 122, respectively. In at least some embodiments, the first device 102 may comprise a switching node coupled via a network connection to one or more remote computer systems and/or devices (not shown). Therefore, the first device 102 may function as a switching device that permits data to be transmitted between the second device 104 and any remote computer systems coupled to the first device 102. The second device 104 may comprise a programmable device such as a field programmable gate array (FPGA). In some embodiments, the second device 104 may be programmed to process and/or combine predetermined data types (e.g., image data) received from remote computers systems coupled to the second device 104 via the first device 102 and the network node adapter 106 as described above. In addition, the second device 104 may process and/or combine data received via the first device 102 with data received from a local computer system coupled to the second device 104.

The first device 102 and the second device 104 may be embodied in one computer system or separate computer systems. Accordingly, the first interface 120 and the second interface 122 may be internal interfaces of a computer or external interfaces that connect multiple computers. Communication between the first device 102 and the second device 104 may involve the first device 104 transmitting data to the second device 102 whereinafter the second device 102 processes, or otherwise modifies the data, and returns the processed data to the first device 104.

In some embodiments, the first device 102 may transmit data (e.g., a process request and associated data mentioned above) to the second device 104 via the first interface 120 which may comprise a full duplex connection (link). As the term is used herein, a full duplex connection refers to a connection in which data may be transmitted between the first device 102 and the network link adapter 106 in both directions simultaneously without affecting the speed of either data transfer. For example, Infiniband 1×, 2×, 4×, and 12× links comprise full duplex connections. Additional full duplex connections may comprise switched Ethernet over twisted pair wire or optical fiber, and Fibrechannel. Likewise, local computer interconnects such as HyperTransport and PCI-Express may comprise full duplex connections. Via the first interface 120, the network link adapter 106 may receive data from the first device 102, whereinafter the network link adapter 106 may examine destination (target) information provided with the data and forward the data to the designated destination.

In some embodiments, the first device 102 may transmit data to any of a variety of devices (e.g., the second device 104) coupled to the network link adapter 106. Accordingly, devices coupled to the network link adapter 106 may each have an assigned address space (e.g., one or more addresses) defined by the network link adapter 106. Therefore, the destination information transmitted with data from the first device 102 to the network link adapter 106 may comprise an address assigned to the address space of the second device 104.

The network link adapter 106 (e.g., a Mellonox® MT23108 adapter) may be configurable to operate in multiple modes. As shown in FIG. 1, the network link adapter 106 may comprise mode logic 114 that receives a mode signal. In some embodiments, the mode signal may be a user-controlled signal that permits the network link adapter to operate in one of multiple modes. Alternatively, the mode signal may be implicit in an address associated with the data received by the network link adapter 106. For example, in a first mode, the network link adapter 106 may forward the data to the second device 104 via the second interface 122 which may comprise a half duplex connection. As the term is used herein, a half duplex connection permits data to be transmitted in one direction at a time between the network link adapter 106 and the second device 104. For example, PCI, PCI-X, AGP and legacy busses such as ISA and EISA may comprise half duplex connections.

In a second mode, the network link adapter 106 may function to forward the data to a memory 108 (e.g., a DDR memory) via a memory interface 124 when the data targets a predetermined device. For example, in some embodiments, when data is intended for the second device 104 (as determined by destination information included with the data), the network link adapter 106 may be configured to forward the data to one or more predetermined addresses (real or dummy addresses) of the memory 108 via the memory interface 124. Therefore, when the first device 102 sends data that is intended for the second device 104, the network link adapter 106 may redirect the data away from the second interface 122 to the memory interface 124. The second interface 122 (which may only transmit data in one direction at a time) is thereby available to transmit data from the second device 104 to the network link adapter 106 as will later be described.

As shown in FIG. 1, the system 100 also may comprise a monitoring unit 110 coupled to the memory interface 124. The monitoring unit 110 is configurable to detect when data forwarded to the memory 108 was originally intended for the second device 104. For example, in some embodiments, the monitoring unit 110 may comprise an address detector 112 that detects when data is written to the one or more predetermined addresses described above. In response to detecting that data is being written to the one or more predetermined addresses, the monitoring unit 110 may intercept the data being written to the memory 108 and forward the data to the second device 104. Alternatively, the monitoring unit may read the data written to the one or more predetermined addresses and forward the data to the second device 104. If the address detector 112 does not detect that the data is associated with the one or more predetermined addresses, the data written to the memory 108 is not forwarded to the second device 104.

In response to receiving the data from the monitoring unit 110, the second device 104 may process the data and return the processed data to the first device 102 via the second interface 122. Therefore, the system 100 allows the second device 104 to receive data from the first device 104 via the alternate route (shown by the dashed line) while sending data to the first device 102 via the second interface 122. Without re-directing the data intended for the second device 104 as described above, the second interface 122 may act as a bottleneck that permits sequential rather than simultaneous communication between the first device 102 and the second device 104 (i.e., the second device 104 would be prevented from outputting data to the first device 102 via the second interface 122 until all the data from the first device 102 has been received and the second interface 122 is available). Therefore, the speed of communication of system 100 may be increased (as much as doubled) by simultaneously providing data (e.g., a processing request) from the first device 102 to the second device 104 through the monitoring unit 110 while allowing the second device 104 to send data (e.g., processed data) back to the first device 102 data via the second interface 122, network link adapter 106, and the first interface 120.

In some embodiments, the system 100 may operate as, at least, part of a scalable graphic rendering system wherein the first device 102 is a network switch capable of dynamically communicating with a plurality of remote computer systems which work together in a coordinated manner to render computer generated imagery. In such embodiments, the second device 104 may process one or more sets of intermediate image data (i.e., data that requires further processing/formatting to create an image) for a local computer that may be coupled to the second device 104 and/or one or more remote computers that may be coupled to the first device 102.

For example, a first set of intermediate image data may be transmitted from a remote computer to the first device 102 via a network connection. The first set of intermediate image data may then be transmitted from the first device 102 to the network link adapter 106 via the first interface 120. Thereafter, pre-established routing information, header information and/or addressing information associated with the incoming first set of intermediate image data may cause the network link adapter 106 to deliver the first set of intermediate image data to one or more pre-determined addresses in memory 108 via the memory interface 124.

As previously described, the monitoring unit 110 may observe the data on the memory interface 124 and forward the data to second device 104 via an alternate interface (the alternate route) that does not interfere with the operation of second interface 122. The second device 104 may combine the first set of intermediate image data with a second set of intermediate image data received from a local computer coupled to the second device 104. The combination of the first and second sets of intermediate image data may produce new image data that may be displayed by the local computer or one of the remote computers. Alternatively, the new image data may comprise intermediate image data that is subject to further processing/combining in the local computer or one of the remote computer systems prior to final display. In at least some embodiments, the remote computer system that provided the first set of intermediate image data to second device 104 is not the same as the remote computer system that may receive the new image data from the second device 104.

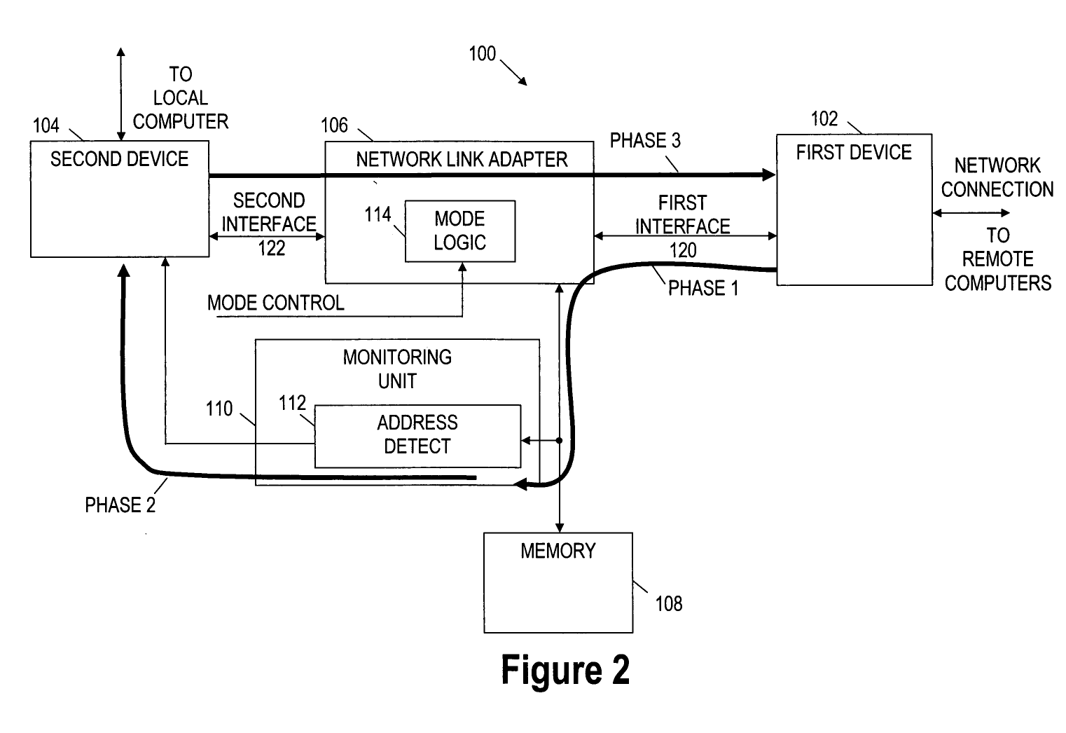

FIG. 2 illustrates a flow of data in the system 100 of FIG. 1 in accordance with embodiments of the invention. As shown in FIG. 2, the flow of data (shown in bold) may be divided into “PHASE 1,” “PHASE 2” and “PHASE 3.” During PHASE 1, data is transmitted from the first device 102 to the network link adapter 106 via the first interface 120. If the second device 104 is the desired recipient of the data and the network link adapter 106 is configured to operate in the second mode described above, the data is forwarded to one or more predetermined addresses of the memory 108. During PHASE 2, the monitoring unit 110 detects that data is being written to the one or more predetermined addresses and forwards the data to the second device 104. The second device 104 may then process the data as requested by the first device 102. During PHASE 3, the processed data is returned to the first device 102 via the second interface 122, the network link adapter 106, and the first interface 120. In at least some embodiments, the PHASES described above may occur substantially simultaneously such that the first device 102 may still be outputting a data process request to the second device 104 while receiving processed data back from the second device 102.

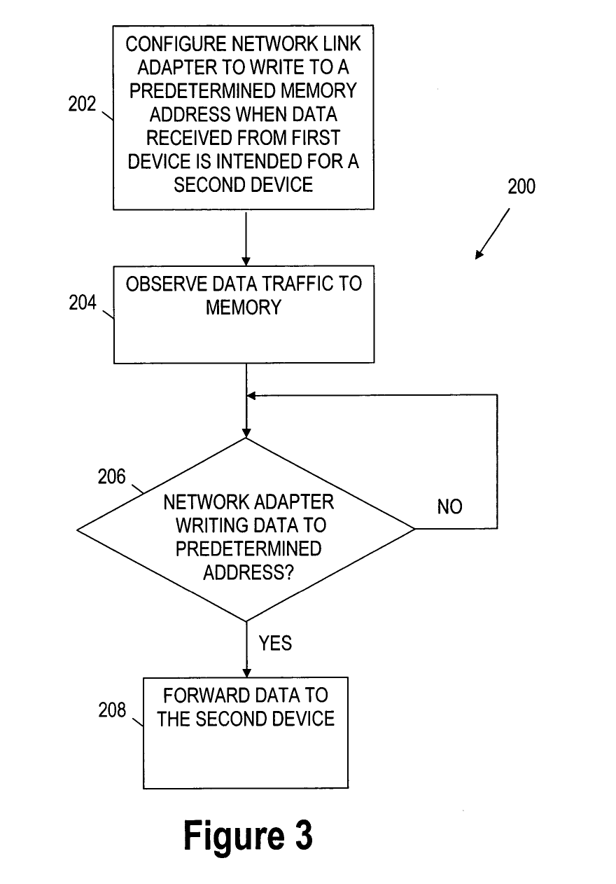

FIG. 3 illustrates a method 200 in accordance with embodiments of the invention. As shown in FIG. 3, the method 200 may comprise configuring a network link adapter to write to a predetermined memory address when data received from a first device is intended for a second device (block 202). At block 204, the data traffic to the memory is observed. If the network link adapter is writing data to the predetermined memory address, as determined at block 206, the data may be forwarded to the second device (block 208). Otherwise, the method 200 waits for the adapter to write data to the predetermined address (block 206).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A system, comprising:
a network link adapter, wherein the network link adapter is configurable to detect when a first device transmits data targeting a second device and, instead of providing the data to the second device, to write the data targeting the second device to an address of a memory; and
a monitoring unit coupled to the network link adapter, the monitoring unit is configurable to detect when the data is being written or has been written to the address of the memory and to forward the data to the second device.

2. The system of claim 1 further comprising a first interface coupled between the first device and the network link adapter, the first interface allows simultaneous bi-directional communication between the first device and the network link adapter.

3. The system of claim 2 further comprising a second interface coupled between the second device and the network link adapter, the second interface allows communication in one direction at a time between the second device and the network link adapter.

4. The system of claim 1 wherein the monitoring unit comprises an address decoder that detects when the network link adapter writes the data to the address of the memory.

5. The system of claim 3 wherein the network link adapter comprises mode logic, the mode logic receives a user-controller mode signal whereby the network link adapter is configurable to operate in a first mode and a second mode.

6. The system of claim 5 wherein the network link adapter, when configured in the first mode, receives the data from the first device via the first interface and forwards the data to the second device via the second interface.

7. The system of claim 5 wherein the network link adapter, when configured in the second mode, detects when the first device transmits the data targeting the second device and writes the data to the address of the memory.

8. The system of claim 3 wherein the second device processes the data for the first device and returns processed data to the first device via the second interface.

9. The system of claim 3 wherein the second device receives the data from the monitoring unit and outputs processed data to the network link adapter via the second interface simultaneously.

10. A method, comprising:
configuring a network link adapter to write to an address of a memory when data received from a first device is intended for a second device;
observing data traffic between the network link adapter and the memory; and
forwarding the data to the second device when the network link adapter writes the data to the address.

11. The method of claim 10 further comprising simultaneously processing the data and outputting processed data by the second device.

12. The method of claim 11 further comprising transmitting the data between the first device and the network link adapter via a full duplex connection.

13. The method of claim 11 further comprising transmitting the processed data from the second device to the network link adapter via a half duplex connection.

14. A system, comprising:
a network link adapter coupled to a first device via a first interface and coupled to a second device via a second interface;
a memory coupled to the network link adapter;
means for configuring the network link adapter to write data to a predetermined memory address when the data is intended for the second device;
means for monitoring data traffic coupled between the memory, the network link adapter, and the second device, wherein the means for monitoring data traffic is operable to forward data to the second device when the network link adapter writes the data to the predetermined address of the memory.

15. The system of claim 14 wherein the first device is operable to simultaneously transmit data to and receive data from the network link adapter.

16. The system of claim 14 wherein the second device is operable to simultaneously transmit data to the network link adapter and receive data from the means for monitoring data traffic.

17. An image rendering system, comprising:
a first device operable to couple to and communicate with one or more remote computer systems;
a second device operable to process one or more sets of image data;
a network link adapter coupled to the first device via a first interface and the second device via a second interface, wherein the network link adapter directs image data received from the first device and intended for the second device to a memory interface; and
a monitoring unit coupled to the memory interface, wherein the monitoring unit detects when image data directed to the memory interface is intended for the second device and sends the image data to the second device without the use of the second interface.

18. The system of claim 17 wherein the second device changes the image data and outputs new image data to one of the remote computer system via the network interface, the network link adapter and the first device.

19. The system of claim 18 wherein the second device receives the image data from the monitoring unit and outputs new image data to the second interface simultaneously.

20. The system of claim 19 wherein the second interface is a half duplex connection.

21. The system of claim 20 wherein the first interface comprises a full duplex interface.

22. The system of claim 17 wherein the image data is written to a predetermined address of a memory coupled to the memory interface.

23. The system of claim 17 wherein the image data is intercepted and forwarded to the second device while being written to a predetermined address of a memory coupled to the memory interface.
